(19) United States
(12) Patent Application Publication
(10) Pub. No.: US 2025/0139734 A1
(43) Pub. Date: May 1, 2025

(54) IMAGE PROCESSING DEVICE, IMAGE PROCESSING METHOD, AND PROGRAM

(71) Applicant: NIPPON TELEGRAPH AND TELEPHONE CORPORATION, Tokyo (JP)

(72) Inventors: Wataru ITO, Tokyo (JP); Atsushi ARATAKE, Tokyo (JP); Yosuke SAKURADA, Tokyo (JP); Daisuke UCHIBORI, Tokyo (JP); Kazuaki WATANABE, Tokyo (JP)

(73) Assignee: NIPPON TELEGRAPH AND TELEPHONE CORPORATION, Tokyo (JP)

(21) Appl. No.: 18/836,148

(22) PCT Filed: Feb. 8, 2022
(86) PCT No.: PCT/JP2022/004976

§ 371 Date: Aug. 6, 2024

(51) Int. Cl. G06T 3/40; G06T 5/50; G06T 9/00

(52) U.S. Cl. CPC G06T 3/40; G06T 5/50; G06T 9/00; G06T 2207/20132; G06T 2207/20221

(57) ABSTRACT

An image processing device (10) according to the present disclosure includes: an image cutting-out unit (12) that cuts out a cutout image including a predetermined object from an input image; an image size standardization unit (13) that performs standardization of a size of the cutout image to a predetermined size; and an image output unit (14) that outputs a cutout image after the standardization, in which the image size standardization unit (13) adds predetermined images in a width direction and a height direction of the cutout image in a case where the size of the cutout image is less than or equal to the predetermined size in both the width direction and the height direction, and adds predetermined images in at least one of the width direction or the height direction of the cutout image to generate an additional image having an aspect ratio identical to that of the predetermined size and compresses the additional image to the predetermined size in a case where the size of the cutout image is greater than the predetermined size in at least one of the width direction or the height direction.

### TECHNICAL FIELD

The present disclosure relates to an image processing device, an image processing method, and a program.

### BACKGROUND ART

As a method of detecting an object or the like in an image by using a deep learning method, there is a method of removing an unnecessary portion (portion not used for determination) in an image to reduce an amount of calculation (for example, cutting out a portion desired to be used for determination by a deep learning method such as You only look once (Yolo)) and detecting an object with respect to an image required for determination (see, for example, Non Patent Literature 1). When an image is cut out, the size of an image (cutout image) cut out from an original image depends on the size of an object to be detected included in the original image, and thus cutout images of various sizes are generated. However, when an object or the like is detected by using the cutout image, it is necessary to unify sizes of images used for detection.

Thus, in general, the image is resized by enlargement or reduction (see, for example, Non Patent Literature 2). Specifically, in a case where the size of the cutout image is less than a predetermined size, the size of the cutout image is standardized to the predetermined size by enlarging the size of the cutout image, and in a case where the size of the cutout image is greater than the predetermined size, the size of the cutout image is standardized to the predetermined size by reducing the size of the cutout image.

### CITATION LIST

### Non Patent Literature

Non Patent Literature 1: Yu Tabata, et al., “UNMANNED INSPECTION ORIENTED UAV BRIDGE INSPECTION AND DAMAGE DETECTION USING DEEP LEARNING”, Journal of Japan Society of Civil Engineers, F4 (Construction Management), Vol. 74, No. 2, p. 62-74, 2018
Non Patent Literature 2: Kenta MUTO, et al., “Image Magnification Method Based on Gradient Direction and Strength by Pixel”, The Journal of the Institute of Image Electronics Engineers of Japan, Vol. 36, No. 3, p. 264-269, 2007

### SUMMARY OF INVENTION

### Technical Problem

However, in the method of resizing the size of the cutout image described above, in a case where aspect ratios do not match between the size of the cutout image and the size to be standardized, an aspect ratio of the pixel region of the object to be detected also changes, and when a model is created by deep learning using the cutout image after standardization, there is a problem that detection accuracy decreases.

That is, in a case where a deep learning method is applied to a cutout image cut out by an algorithm such as Yolo to detect an object or the like in the image, it is necessary to unify (standardize) the size of the image to be used (cutout image); however, in existing technologies, it is difficult to standardize the size of the image while maintaining an aspect ratio of the object included in the image.

An object of the present disclosure made in view of the above problem is to provide an image processing device, an image processing method, and a program capable of standardizing the size of a cutout image obtained by cutting out a region including a predetermined object to a predetermined size while maintaining an aspect ratio of the object.

### Solution to Problem

To solve the above problem, an image processing device according to the present disclosure includes: an image cutting-out unit that cuts out an image of a rectangular region including a predetermined object from an input image as a cutout image; an image size standardization unit that performs standardization of a size of the cutout image to a predetermined size while maintaining an aspect ratio of the object; and an image output unit that outputs a cutout image after the standardization, in which the image size standardization unit performs standardization of the size of the cutout image to the predetermined size by adding predetermined images in a width direction and a height direction of the cutout image in a case where the size of the cutout image is less than or equal to the predetermined size in both the width direction and the height direction, and performs standardization of the size of the cutout image to the predetermined size by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

Furthermore, to solve the above problem, an image processing method according to the present disclosure is an image processing method by an image processing device, and the image processing method includes: a step of cutting out an image of a rectangular region including a predetermined object from an input image as a cutout image; a step of performing standardization of a size of the cutout image to a predetermined size while maintaining an aspect ratio of the object; and a step of outputting a cutout image after the standardization, in which standardization of the size of the cutout image to the predetermined size is performed by adding predetermined images in a width direction and a height direction of the cutout image in a case where the size of the cutout image is less than or equal to the predetermined size in both the width direction and the height direction, and standardization of the size of the cutout image to the predetermined size is performed by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

Furthermore, to solve the above problem, a program according to the present disclosure causes a computer to operate as the image processing device described above.

### Advantageous Effects of Invention

According to the image processing device, the image processing method, and the program according to the present disclosure, it is possible to standardize the size of a cutout image obtained by cutting out a region including a predetermined object to a predetermined size while maintaining an aspect ratio of the object.

### BRIEF DESCRIPTION OF DRAWINGS

FIG. 1 is a diagram illustrating a configuration example of an image processing device according to an embodiment of the present disclosure.

FIG. 2 is a diagram illustrating a configuration example of an image size standardization unit illustrated in FIG. 1.

FIG. 3 is a diagram illustrating an example of standardization of a size of a cutout image by an image expansion unit illustrated in FIG. 2.

FIG. 4 is a diagram illustrating another example of the standardization of the size of the cutout image by the image expansion unit illustrated in FIG. 2.

FIG. 5 is a diagram illustrating still another example of the standardization of the size of the cutout image by the image expansion unit illustrated in FIG. 2.

FIG. 6A is a diagram illustrating an example of a pattern of expansion of the cutout image by the image expansion unit illustrated in FIG. 2.

FIG. 6B is a diagram illustrating another example of the pattern of the expansion of the cutout image by the image expansion unit illustrated in FIG. 2.

FIG. 6C is a diagram illustrating still another example of the pattern of the expansion of the cutout image by the image expansion unit illustrated in FIG. 2.

FIG. 6D is a diagram illustrating still another example of the expansion of the cutout image by the image expansion unit illustrated in FIG. 2.

FIG. 7A is a diagram illustrating an example of the standardization of the size of the cutout image by the image compression unit illustrated in FIG. 2.

FIG. 7B is a diagram illustrating another example of the standardization of the size of the cutout image by the image compression unit illustrated in FIG. 2.

FIG. 8 is a flowchart illustrating an example of operation of the image processing device illustrated in FIG. 1.

FIG. 9 is a diagram illustrating an example of a hardware configuration of the image processing device illustrated in FIG. 1.

### DESCRIPTION OF EMBODIMENTS

Hereinafter, an embodiment of the present disclosure will be described with reference to the drawings.

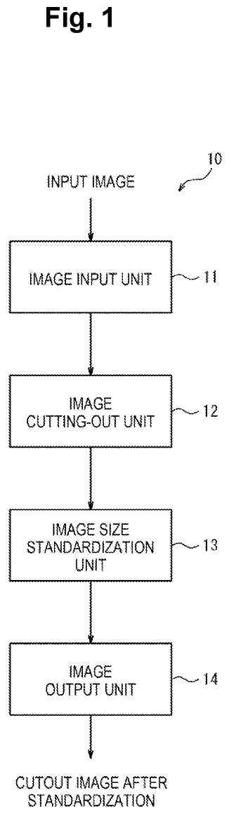

FIG. 1 is a diagram illustrating a configuration example of an image processing device 10 according to an embodiment of the present disclosure. The image processing device 10 according to the present embodiment generates and outputs a cutout image that is an image obtained by cutting out a region including a predetermined object included in an input image from the input image. The input image is, for example, an image obtained by capturing an image of an infrastructure facility (for example, a utility pole or the like). In this case, the image processing device 10 cuts out, from the input image, an image of an approximate region including the infrastructure facility and outputs the image as a cutout image. The cutout image generated by the image processing device 10 is used, for example, for detection of a predetermined object (for example, infrastructure facility) in the image.

As illustrated in FIG. 1, the image processing device 10 according to the present embodiment includes an image input unit 11, an image cutting-out unit 12, an image size standardization unit 13, and an image output unit 14.

An image to be a source of generation of a cutout image is input to the image input unit 11. As described above, the input image input to the image input unit 11 is, for example, an image obtained by capturing an image of a predetermined infrastructure facility. The image input unit 11 outputs the input image to the image cutting-out unit 12.

The image cutting-out unit 12 cuts out an image of an approximate region including a predetermined object into a rectangle from the input image output from the image input unit 11. That is, the image cutting-out unit 12 cuts out an image of a rectangular region including a predetermined object from the input image as a cutout image. The image cutting-out unit 12 cuts out a cutout image including a predetermined object from the input image by using, for example, a detector created in advance by a deep learning method such as Yolo.

By generating a cutout image from the input image, for example, when an object in an image is detected by using a deep learning method, it is possible to remove a portion unnecessary for detection to reduce an image size and to prevent a decrease in calculation speed at the time of deep learning. Furthermore, by generating a cutout image from the input image, a possibility of erroneously detecting an object that is not a detection target is reduced, so that detection accuracy can be improved.

The image cutting-out unit 12 outputs the cutout image cut out from the input image to the image size standardization unit 13 together with the input image as necessary.

The image size standardization unit 13 standardizes a size of the cutout image to a predetermined size (standardized size) while maintaining an aspect ratio of a predetermined object included in the cutout image output from the image cutting-out unit 12.

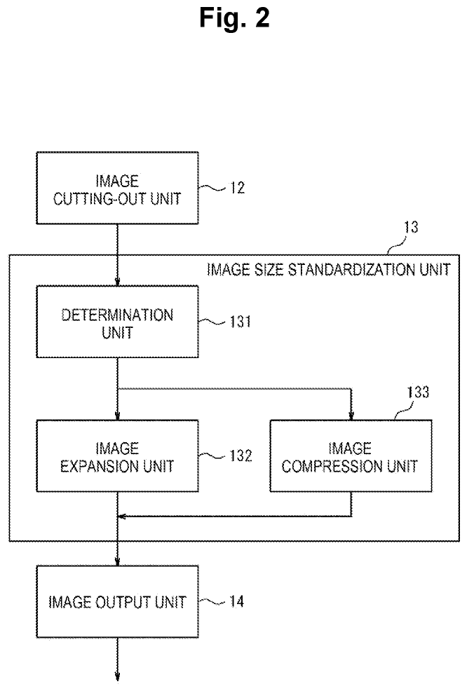

FIG. 2 is a diagram illustrating a configuration example of the image size standardization unit 13.

As illustrated in FIG. 2, the image size standardization unit 13 includes a determination unit 131, an image expansion unit 132, and an image compression unit 133.

A cutout image is input to the determination unit 131 from the image cutting-out unit 12. The determination unit 131 determines whether or not the size of the input cutout image exceeds the standardized size in the width direction and the height direction. For example, the determination unit 131 determines whether or not the numbers of pixels in the width direction and the height direction of the cutout image exceed the number of pixels in the width direction (X(pix)) and the number of pixels in the height direction (Y(pix)) of the standardized size, respectively.

In a case where it is determined that the size of the cutout image is less than or equal to the standardized size in both the width direction and the height direction, the determination unit 131 outputs the cutout image to the image expansion unit 132. Furthermore, in a case where it is determined that the size of the cutout image is greater than the standardized size in at least one of the width direction or the height direction, the determination unit 131 outputs the cutout image to the image compression unit 133.

The image expansion unit 132 performs standardization of the size of the cutout image to the standardized size by adding predetermined images in the width direction and the height direction of the cutout image output from the determination unit 131, and outputs a cutout image after the standardization to the image output unit 14. Details of the standardization of the size of the cutout image by the image expansion unit 132 will be described later.

The image compression unit 133 generates an additional image obtained by adding predetermined images to at least one of the width direction or the height direction of the cutout image output from the determination unit 131. Then, the image compression unit 133 performs standardization of the size of the cutout image to the standardized size by compressing the generated additional image to the standardized size, and outputs a cutout image after the standardization to the image output unit 14. Details of the standardization of the size of the cutout image by the image compression unit 133 will be described later.

As described above, in a case where the size of the cutout image is less than or equal to the standardized size (predetermined size) in both the width direction and the height direction, the image size standardization unit 13 standardizes the size of the cutout image to the standardized size by adding predetermined images in the width direction and the height direction of the cutout image. Furthermore, in a case where the size of the cutout image is greater than the standardized size in at least one of the width direction or the height direction, the image size standardization unit 13 adds predetermined images to at least one of the width direction or the height direction of the cutout image to generate an additional image having the same aspect ratio as that of the standardized size. Then, the image size standardization unit 13 standardizes the size of the cutout image to the standardized size by compressing the generated additional image to the standardized size.

Referring again to FIG. 1, the image output unit 14 outputs an image group including the cutout images after the standardization output from the image size standardization unit 13 (the image expansion unit 132 and the image compression unit 133).

Next, a description will be given of the standardization of the size of the cutout image by the image expansion unit 132 and the image compression unit 133.

First, a description will be given of the standardization of the size of the cutout image by the image expansion unit 132.

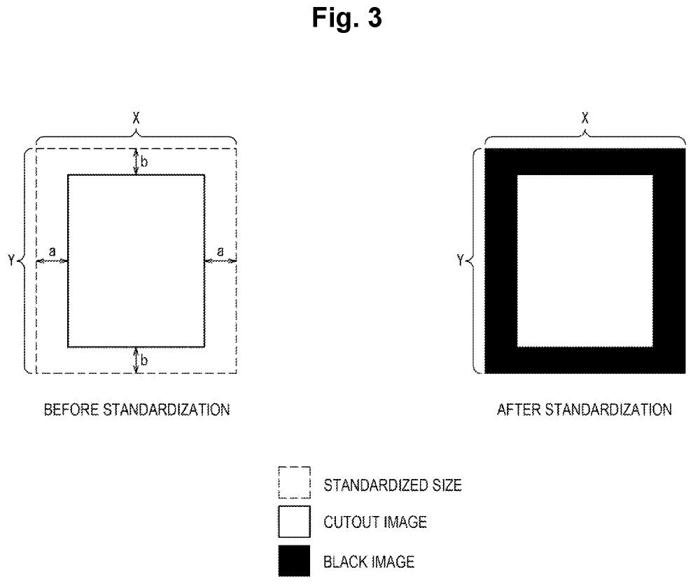

FIG. 3 is a diagram illustrating an example of the standardization of the size of the cutout image by the image expansion unit 132.

As illustrated in FIG. 3, the image expansion unit 132 expands the cutout image by adding predetermined images each having a width a respectively to the left and right of the cutout image so that a size in the width direction of the cutout image becomes a size X in the width direction of the standardized size. Furthermore, the image expansion unit 132 expands the cutout image by adding predetermined images each having a height b to the top and bottom of the cutout image so that a size in the height direction of the cutout image becomes a size Y in the height direction of the standardized size. That is, the image expansion unit 132 adds predetermined images symmetrically on both sides in the width direction of the cutout image (with the same width on both sides in the width direction of the cutout image). Furthermore, the image expansion unit 132 adds predetermined images symmetrically on both sides in the height direction of the cutout image (with the same height on both sides in the height direction of the cutout image).

Here, for example, as illustrated in FIG. 3, the image expansion unit 132 adds images including uniform pixels (in the example of FIG. 3, black images including only black pixels) as predetermined images to both sides in the width direction and both sides in the height direction of the cutout image.

In this manner, by adding predetermined images (for example, black images) in the width direction and the height direction of the cutout image, it is possible to standardize the size of the cutout image to the standardized size while maintaining an aspect ratio of the cutout image before the standardization, that is, an aspect ratio of the object included in the cutout image.

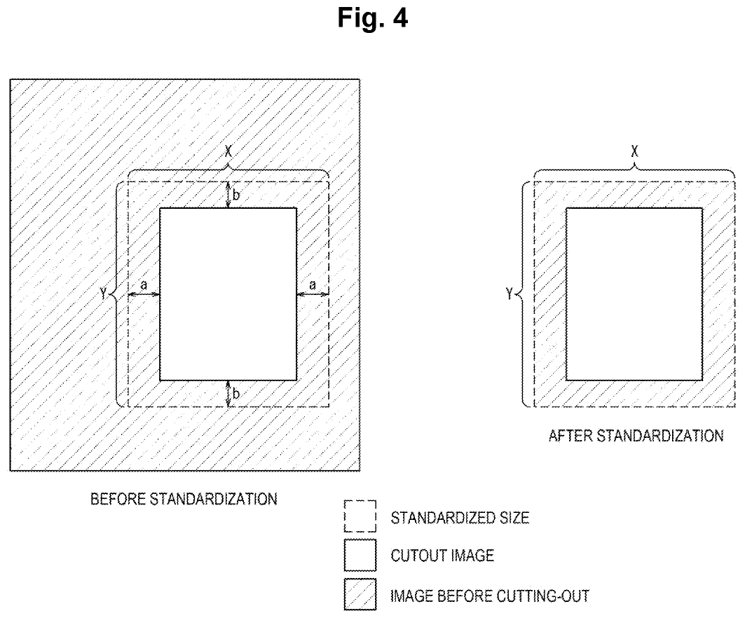

In the example described with reference to FIG. 3, images including uniform pixels are added to the cutout image to standardize the size of the cutout image. For that reason, when deep learning is performed using the cutout image after the standardization, it is learned that information is not included in regions including uniform pixels present on the top, bottom, left, and right of the cutout image before the standardization, and there is a problem that the detection accuracy of an object may decrease in regions corresponding to the images including uniform pixels or the periphery thereof. A description will be given of standardization of the size of the cutout image by the image expansion unit 132 in which this problem is dealt with, with reference to FIG. 4.

As described with reference to FIG. 3, the image expansion unit 132 adds the predetermined images each having the width a to the left and right of the cutout image so that the size in the width direction of the cutout image becomes the size X in the width direction of the standardized size. Furthermore, the image expansion unit 132 adds the predetermined images each having the height b to the top and bottom of the cutout image so that the size in the height direction of the cutout image becomes the size Y in the height direction of the standardized size.

Here, as illustrated in FIG. 4, the image expansion unit 132 adds, as the predetermined images, images around the cutout image in the image before cutting-out of the cutout image (that is, the input image) to both sides in the width direction and both sides in the height direction of the cutout image.

In this manner, by standardizing the size of the cutout image by adding the images around the cutout image in the image before cutting-out to the cutout image, it is possible to prevent the decrease in the detection accuracy of the object described above.

Note that, in FIG. 4, the image expansion unit 132 adds images around the cutout image in the image before cutting-out symmetrically to both sides in the width direction of the cutout image. Furthermore, the image expansion unit 132 adds images around the cutout image in the image before cutting-out symmetrically to both sides in the height direction of the cutout image. However, such an image may not be able to be added depending on a position of cutting-out of the cutout image from the input image.

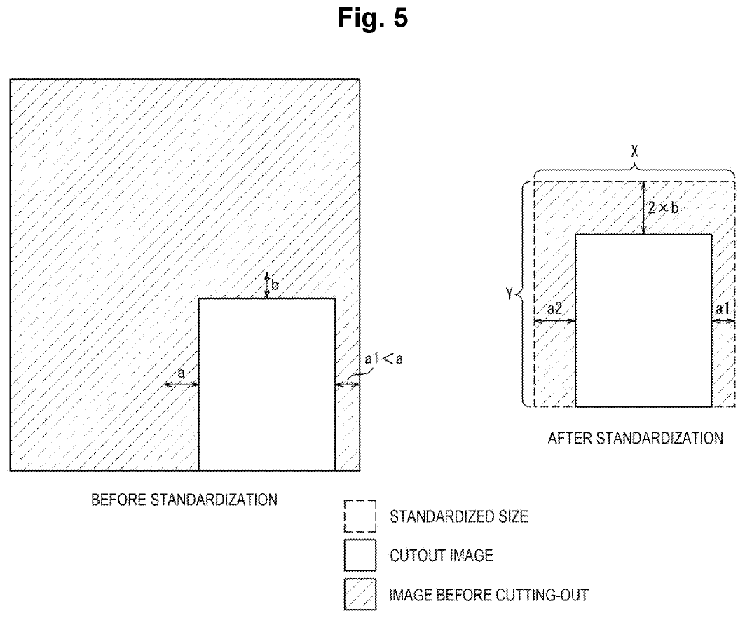

For example, as illustrated in FIG. 5, it is assumed that the bottom side of the cutout image overlaps the bottom side of the image before cutting-out, and a width a1 between the right side of the cutout image and the right side of the image before cutting-out is less than the width a. In this case, it is not possible to add an image before cutting-out having the height b to the lower side of the cutout image, and it is not possible to add an image before cutting-out having the width a to the right hand side of the cutout image.

In this case, as illustrated in FIG. 5, the image expansion unit 132 adds an image before cutting-out having a width a1 to the right hand side of the cutout image, and adds an image before cutting-out having a width a2 (a1+a2=2×a) to the left hand side of the cutout image. Furthermore, the image expansion unit 132 adds an image before cutting-out having a height of 2×b to the upper side of the cutout image. That is, the image expansion unit 132 may add images around the cutout image in the input image asymmetrically in the width direction of the cutout image, and may add images around the cutout image in the input image asymmetrically in the height direction of the cutout image to the cutout image. By doing this, regardless of the position of the cutout image in the input image, it is possible to standardize the size of the cutout image by using the image before cutting-out (input image).

Furthermore, as illustrated in FIG. 4, even in a case where there is a sufficient interval between the top, bottom, left, and right sides of the image before cutting-out and the top, bottom, left, and right sides of the cutout image, the image expansion unit 132 may add images around the cutout image in the input image asymmetrically in the width direction of the cutout image and/or add images around the cutout image in the input image asymmetrically in the height direction of the cutout image to the cutout image.

In a case where an image around a cutout region in the image before cutting-out is added to the cutout image, if an object other than the detection target is included in the image to be added, erroneous detection may be induced in a model created by deep learning using the cutout image after the standardization.

Thus, the image expansion unit 132 may expand the cutout image by adding an image before cutting-out in a direction in which an object other than the object to be detected is not included (for example, a direction in which there are many backgrounds that are considered not to cause erroneous detection).

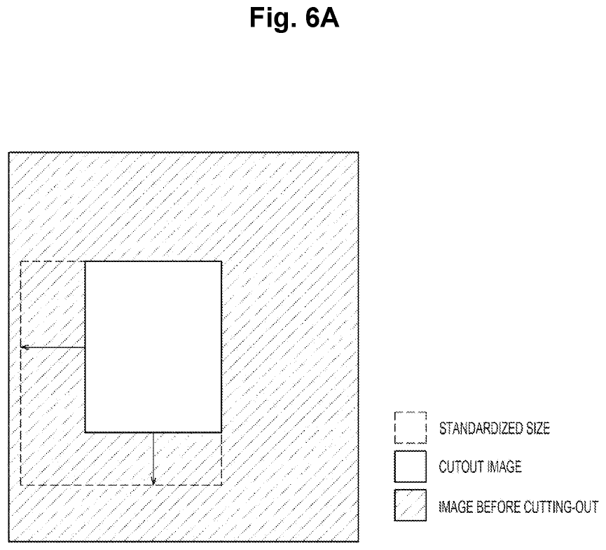

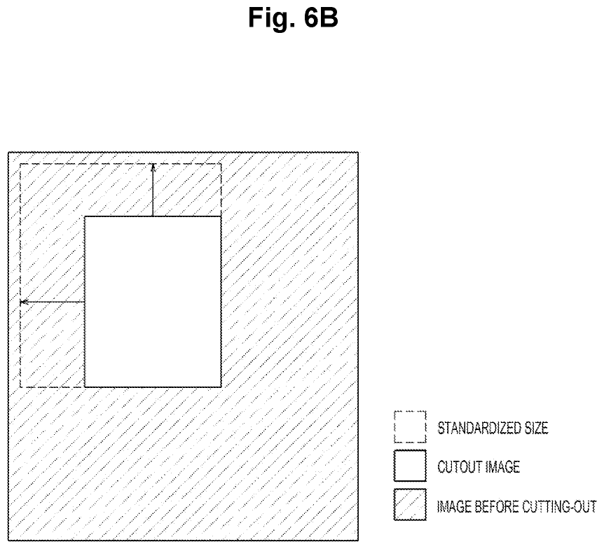

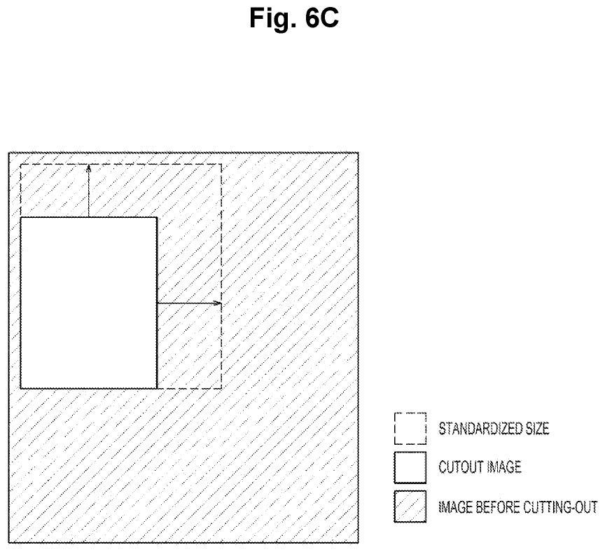

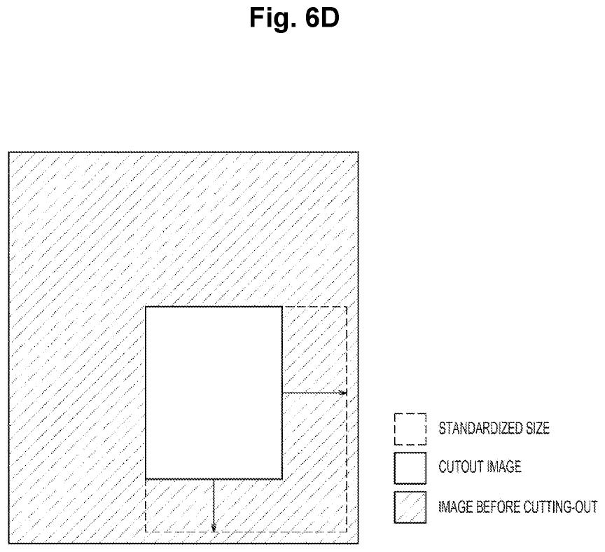

As a method of expanding the cutout image in the direction in which an object other than the object to be detected is not included, there is a method of expanding the cutout image so that the number of pixels having pixel values close to a pixel value of a background color increases in an expansion image that expands the cutout image. Hereinafter, this method will be described with reference to FIGS. 6A to 6D.

FIGS. 6A to 6D are diagrams illustrating examples of patterns for expanding the cutout image by adding an image around the cutout image in an image before cutting-out to the cutout image. FIG. 6A is a diagram illustrating an example in which the cutout image is maximally expanded in the left direction and the downward direction. FIG. 6B is a diagram illustrating an example in which the cutout image is maximally expanded in the left direction and the upward direction. FIG. 6C is a diagram illustrating an example in which the cutout image is maximally expanded in the right direction and the upward direction. FIG. 6D is a diagram illustrating an example in which the cutout image is maximally expanded in the right direction and the downward direction. However, it is assumed that expansion of the cutout image is performed within the image before cutting-out.

The image expansion unit 132 performs four patterns of expansion of the cutout image illustrated in FIGS. 6A to 6D. Hereinafter, pixel values of a pixel i (i is an integer satisfying 1≤i≤N) constituting an image (expansion image) of a region expanded in each pattern are set as Rᵢ, Gᵢ, and Bᵢ, and for example, predetermined pixel values corresponding to the background color are set as R, G, and B.

A value αᵢ representing closeness between the pixel values Rᵢ, Gᵢ, and Bᵢ of the pixel i and the predetermined pixel values R, G, and B is expressed by Formula (1) below.

$$\begin{matrix}[ Math . 1 ] & \\ {α}_{i} = \sqrt{{( R - {R}_{i} )}^{2} + {( G - {G}_{i} )}^{2} + {( B - {B}_{i} )}^{2}} & Formula ( 1 )\end{matrix}$$

The image expansion unit 132 calculates γ for each pattern illustrated in FIGS. 6A to 6D on the basis of Formula (2) below.

$$\begin{matrix}[ Math . 2 ] & \\ γ = f ( {α}_{i} ) & Formula ( 2 )\end{matrix}$$

Here, γ is a monotonically increasing function with respect to αᵢ. An example of the function of γ is expressed by Formula (3) below.

$$\begin{matrix}[ Math . 3 ] & \\ γ = {\sum }_{1 = 1}^{N} {α}_{i} & Formula ( 3 )\end{matrix}$$

The γ represents how far a color of the entire expansion image is from the background color. Thus, the image expansion unit 132 expands the cutout image with a pattern having a minimum γ among the four patterns illustrated in FIGS. 6A to 6D. That is, the image expansion unit 132 adds an image around the cutout image in the image before cutting-out (input image) to the cutout image so that a pixel value of a pixel constituting an image (expansion image) to be added to the cutout image approaches a predetermined pixel value. By doing this, it is possible to expand the cutout image in a direction in which there is a low possibility that an object other than the detection target is included (a direction close to the background color).

Note that the patterns for expanding the cutout image are not limited to the four patterns illustrated in FIGS. 6A to 6D. The image expansion unit 132 can calculate γ for any pattern expanded in the upward, downward, left, and right directions by any length. As the number of patterns for calculating γ increases, processing speed decreases due to an increase in an amount of calculation, but it is possible to determine a pattern for expanding the cutout image in a direction closer to the background color.

Furthermore, in the example described above, the image expansion unit 132 calculates αᵢ for all the pixels i constituting the expansion image, but the present invention is not limited thereto. The image expansion unit 132 may calculate αᵢ for n pixels i randomly selected from all the pixels constituting the expansion image. By doing this, the amount of calculation can be reduced, and the direction close to the background color can be more quickly determined.

Furthermore, the image expansion unit 132 may calculate αᵢ for n pixels i by repeating the calculation of αᵢ for a pixel at a certain distance away from a certain pixel i after determination for the certain pixel i. By doing this, it is possible to increase the calculation speed as compared with the case of calculating αᵢ for all the pixels i. Furthermore, in a case where αᵢ is randomly calculated for n pixels i, in some cases, the n pixels may be concentrated in a certain region of an expansion region, and it may not be possible to determine whether or not the expansion region is close to the background in view of features of the entire expansion region. In this method, it is possible to prevent n pixels from concentrating in a certain region of the expansion region, and it is possible to more appropriately determine whether or not the expansion region is close to the background.

Furthermore, in the example described above, the closeness to the background color is calculated by using the RGB values of the pixel i, but the present invention is not limited thereto, and the image expansion unit 132 may use pixel values of other color spaces (for example, HSV, L*a*b). Furthermore, the image expansion unit 132 may use a pixel value of a grayscale image. By use of the pixel value of the grayscale image, pixel values used for calculation are reduced, so that the calculation speed can be increased.

Furthermore, a model for detecting a background region may be created in advance by deep learning, and the image expansion unit 132 may determine a region close to the background color by using the model. In this case, for example, when an expanded cutout image expanded with each pattern illustrated in FIGS. 6A to 6D is input to the model, an area of the background region in the image of each pattern is automatically calculated. The image expansion unit 132 expands the cutout image along a pattern in which the calculated area is maximum. By using deep learning for learning of the model, it is possible to determine whether or not the pixel i is a pixel in the background region while considering not only the pixel value for each pixel i but also pixel values of pixels around the pixel i. For that reason, it is possible to detect the background region with high accuracy and generate a cutout image expanded in a direction closer to the background.

Next, a description will be given of compression of the cutout image by the image compression unit 133.

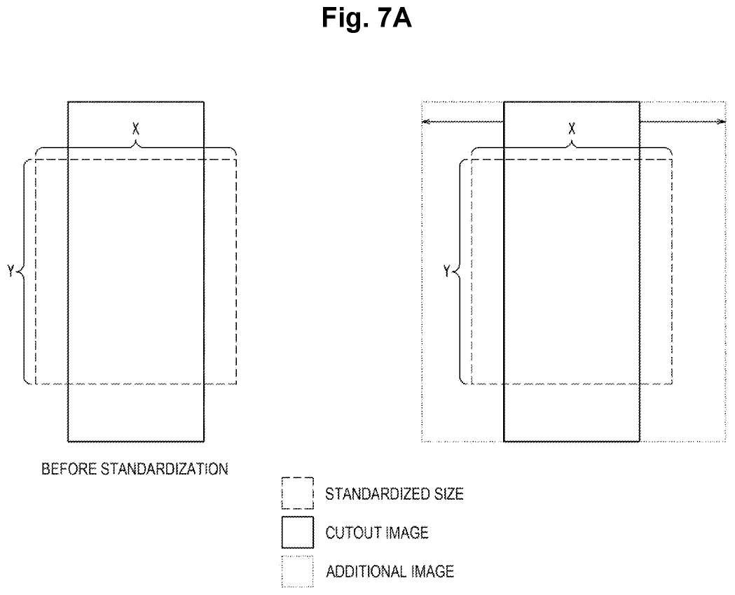

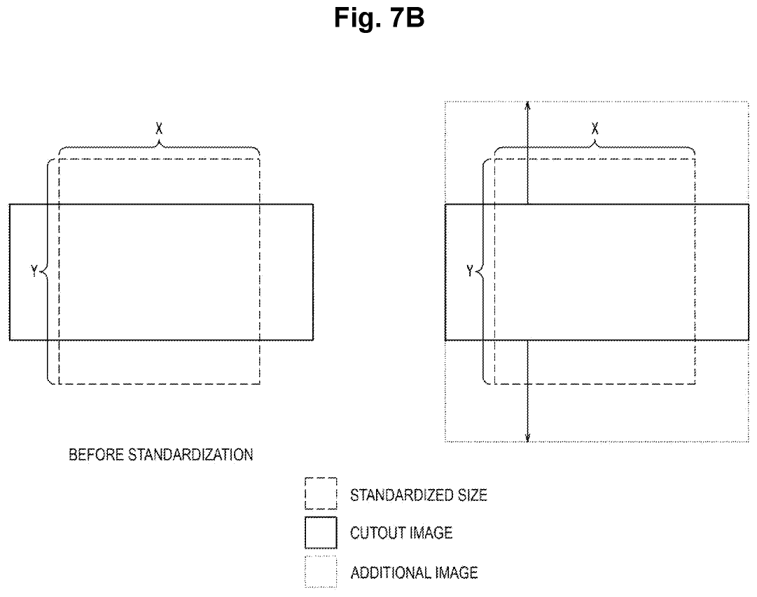

FIG. 7A is a diagram illustrating an example of the standardization of the size of the cutout image by the image compression unit 133. In FIG. 7A, a description will be given using an example in which the cutout image is less in the width direction and greater in the height direction than the standardized size.

In a case where the cutout image is less in the width direction and greater in the height direction than the standardized size, as illustrated in FIG. 7A, the image compression unit 133 adds predetermined images to the left and right of the cutout image to generate an image (Hereinafter, the image is referred to as an “additional image”.) having the same aspect ratio as that of the standardized size. Then, the image compression unit 133 compresses the generated additional image to the standardized size.

FIG. 7B is a diagram illustrating another example of the standardization of the size of the cutout image by the image compression unit 133. In FIG. 7B, a description will be given using an example in which the cutout image is greater in the width direction and less in the height direction than the standardized size.

In a case where the cutout image is greater in the width direction and less in the height direction than the standardized size, as illustrated in FIG. 7B, the image compression unit 133 adds predetermined images to the top and bottom of the cutout image to generate an additional image having the same aspect ratio as that of the standardized size. Then, the image compression unit 133 compresses the generated additional image to the standardized size.

Furthermore, in a case where the cutout image is greater than the standardized size in both the width direction and the height direction, the image compression unit 133 adds predetermined images to at least one of the width direction or the height direction of the cutout image, and generates an additional image having the same aspect ratio as that of the standardized size. Then, the image compression unit 133 compresses the generated additional image to the standardized size.

As described above, in a case where the size of the cutout image is greater than the standardized size, the image compression unit 133 (image size standardization unit 13) adds predetermined images to at least one of the width direction or the height direction of the cutout image to generate an additional image having the same aspect ratio as that of the standardized size. Then, the image compression unit 133 (image size standardization unit 13) standardizes the size of the cutout image to the standardized size by compressing the generated additional image to the standardized size.

By adding predetermined images to the cutout image to generate an additional image having the same aspect ratio as that of the standardized size, and compressing the generated additional image to the standardized size, it is possible to standardize the size of the cutout image to the standardized size while maintaining the aspect ratio of the cutout image, that is, the aspect ratio of the object included in the cutout image.

Note that, similarly to the image expansion unit 132, the image compression unit 133 adds uniform images, or images around the cutout image in the image before cutting-out (input image), as predetermined images to the cutout image.

Furthermore, although FIG. 7A illustrates an example in which predetermined images are added symmetrically in the width direction of the cutout image, and FIG. 7B illustrates an example in which predetermined images are added symmetrically in the height direction of the cutout image, the present invention is not limited thereto. Similarly to the image expansion unit 132, the image compression unit 133 may add images around the cutout image in the image before cutting-out (input image) asymmetrically in the width direction of the cutout image and/or add images around the cutout image in the image before cutting-out (input image) asymmetrically in the height direction of the cutout image to the cutout image.

Next, a description will be given of operation of the image processing device 10 according to the present embodiment.

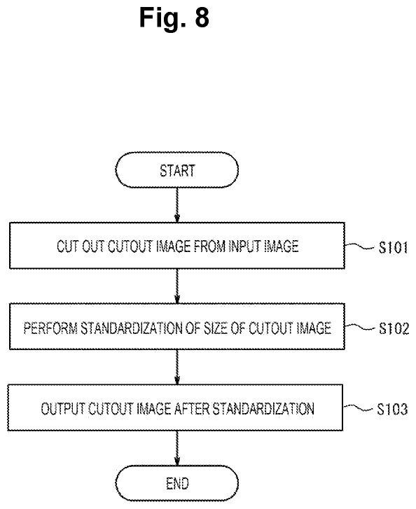

FIG. 8 is a flowchart illustrating an example of the operation of the image processing device 10 according to the present embodiment, and is a diagram for explaining an image processing method by the image processing device 10.

The image cutting-out unit 12 cuts out, from the input image, an image of a rectangular region including a predetermined object as a cutout image (step S101).

The image size standardization unit 13 performs standardization of the size of the cutout image to a predetermined size (standardized size) while maintaining the aspect ratio of the object included in the cutout image (step S102). Specifically, in a case where the size of the cutout image is less than or equal to the standardized size in both the width direction and the height direction, the image size standardization unit 13 standardizes the size of the cutout image to the standardized size by adding predetermined images in the width direction and the height direction of the cutout image. Furthermore, in a case where the size of the cutout image is greater than the standardized size in at least one of the width direction or the height direction, the image size standardization unit 13 adds predetermined images to at least one of the width direction or the height direction of the cutout image to generate an additional image having the same aspect ratio as that of the standardized size. Then, the image size standardization unit 13 standardizes the size of the cutout image to the standardized size by compressing the generated additional image to the standardized size.

The image output unit 14 outputs a cutout image after the standardization by the image size standardization unit 13 (step S103).

Next, a description will be given of a hardware configuration of the image processing device 10 according to the present embodiment.

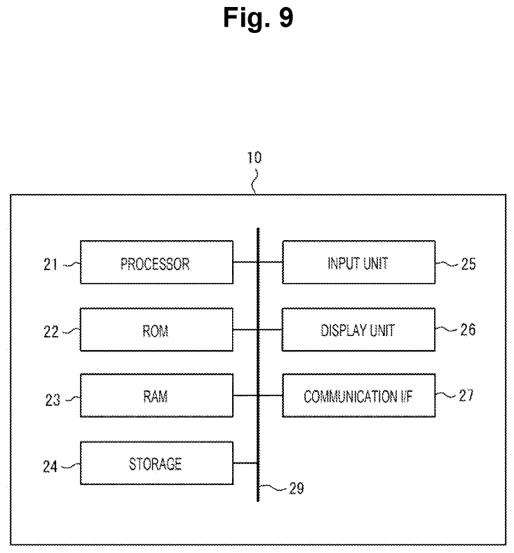

FIG. 9 is a diagram illustrating an example of the hardware configuration of the image processing device 10 according to the present embodiment. FIG. 9 illustrates an example of the hardware configuration of the image processing device 10 in a case where the image processing device 10 includes a computer capable of executing program instructions. Here, the computer may be a general-purpose computer, a dedicated computer, a workstation, a personal computer (PC), an electronic notepad, or the like. The program instructions may be program codes, code segments, and the like for executing a required task.

As illustrated in FIG. 9, the image processing device 10 includes a processor 21, a read only memory (ROM) 22, a random access memory (RAM) 23, a storage 24, an input unit 25, a display unit 26, and a communication interface (I/F) 27. The components are communicably connected with each other via a bus 29. Specifically, the processor 21 is a central processing unit (CPU), a micro processing unit (MPU), a graphics processing unit (GPU), a digital signal processor (DSP), a system on a chip (SoC), or the like, and may be configured by a plurality of processors of the same type or different types.

The processor 21 is a control unit that executes control of the components and various types of arithmetic processing. That is, the processor 21 reads a program from the ROM 22 or the storage 24 and executes the program using the RAM 23 as a work area. The processor 21 executes control of the components and various types of arithmetic processing in accordance with a program stored in the ROM 22 or the storage 24. In the present embodiment, the ROM 22 or the storage 24 stores a program for causing the computer to function as the image processing device 10 according to the present disclosure. The program is read and executed by the processor 21, whereby the components of the image processing device 10 described above are implemented.

The program may be provided in a form in which the program is stored in a non-transitory storage medium, such as a compact disk read only memory (CD-ROM), a digital versatile disk read only memory (DVD-ROM), or a universal serial bus (USB) memory. Furthermore, the program may be downloaded from an external device via a network.

The ROM 22 stores various programs and various types of data. The RAM 23 as a work area temporarily stores programs or data. The storage 24 includes a hard disk drive (HDD) or a solid state drive (SSD) and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by employing a touchscreen system.

The communication interface 27 is an interface for communicating with other devices, and is, for example, an interface for a LAN. For example, an image as a target of cutting-out of the cutout image is input to the image input unit 11 via the communication interface 27. Furthermore, for example, a cutout image after the standardization is output to the outside via the communication interface 27.

A computer can be suitably used to function as each unit of the image processing device 10 described above. Such a computer can be implemented by storing a program in which processing contents for implementing a function of each unit of the image processing device 10 are written in a storage unit of the computer and causing a processor of the computer to read and execute the program. That is, the program can cause the computer to function as the image processing device 10 described above. Furthermore, the program can also be recorded in a non-transitory storage medium. Furthermore, the program can also be provided via the network.

As described above, the image processing device 10 according to the present embodiment includes the image cutting-out unit 12, the image size standardization unit 13, and the image output unit 14. The image cutting-out unit 12 cuts out an image of a rectangular region including a predetermined object from the input image as a cutout image. The image size standardization unit 13 performs standardization of the size of the cutout image to a predetermined size while maintaining the aspect ratio of the object. The image output unit 14 outputs a cutout image after the standardization. Here, in a case where the size of the cutout image is less than or equal to a predetermined size in both the width direction and the height direction, the image size standardization unit 13 standardizes the size of the cutout image to the predetermined size by adding predetermined images in the width direction and the height direction of the cutout image. Furthermore, in a case where the size of the cutout image is greater than the predetermined size in at least one of the width direction or the height direction, the image size standardization unit 13 adds predetermined images to at least one of the width direction or the height direction of the cutout image to generate an additional image having the same aspect ratio as that of the predetermined size, and compresses the additional image to the predetermined size, thereby standardizing the size of the cutout image to the predetermined size.

Furthermore, the image processing method according to the embodiment includes: a step of cutting out, by the image cutting-out unit 12, an image of a rectangular region including a predetermined object as a cutout image from the input image (step S101); a step of performing standardization, by the image size standardization unit 13, of the size of the cutout image to a predetermined size while maintaining the aspect ratio of the object (step S102); and a step of outputting, by the image output unit 14, a cutout image after the standardization (step S103). Here, in a case where the size of the cutout image is less than or equal to a predetermined size in both the width direction and the height direction, the image size standardization unit 13 standardizes the size of the cutout image to the predetermined size by adding predetermined images in the width direction and the height direction of the cutout image. Furthermore, in a case where the size of the cutout image is greater than the predetermined size in at least one of the width direction or the height direction, the image size standardization unit 13 adds predetermined images to at least one of the width direction or the height direction of the cutout image to generate an additional image having the same aspect ratio as that of the predetermined size, and compresses the additional image to the predetermined size, thereby standardizing the size of the cutout image to the predetermined size.

By standardizing the size of the cutout image by adding predetermined images to the cutout image or adding predetermined images to the cutout image to generate an additional image having the same aspect ratio as that of the predetermined size and compressing the generated additional image, it is possible to standardize the size of the cutout image to the predetermined size while maintaining the aspect ratio of the object.

With regard to the above embodiments, the following supplementary notes are further disclosed.

### [Supplement 1]

An image processing device including:
a memory; and
a control unit connected to the memory, in which
the control unit
cuts out an image of a rectangular region including a predetermined object from an input image as a cutout image,
performs standardization of a size of the cutout image to a predetermined size while maintaining an aspect ratio of the object, and
outputs a cutout image after the standardization, and
the control unit performs standardization of the size of the cutout image to the predetermined size by adding predetermined images in a width direction and a height direction of the cutout image in a case where the size of the cutout image is less than or equal to the predetermined size in both the width direction and the height direction, and performs standardization of the size of the cutout image to the predetermined size by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

### [Supplement 2]

The image processing device according to supplement 1, in which
the control unit adds, as the predetermined images, images including uniform pixels to the cutout image.

### [Supplement 3]

The image processing device according to supplement 1, in which
the control unit adds, as the predetermined images, images around the cutout image in the input image to the cutout image.

### [Supplement 4]

The image processing device according to supplement 1, in which
the control unit adds the predetermined images symmetrically to both sides in the width direction of the cutout image and/or adds the predetermined images symmetrically to both sides in the height direction of the cutout image.

### [Supplement 5]

The image processing device according to supplement 3, in which
the control unit adds the images around the cutout image in the input image asymmetrically in the width direction of the cutout image and/or adds the images around the cutout image in the input image asymmetrically in the height direction of the cutout image.

### [Supplement 6]

The image processing device according to supplement 5, in which
the control unit adds the images around the cutout image in the input image to the cutout image such that a pixel value of a pixel constituting the image to be added to the cutout image approaches a predetermined pixel value.

### [Supplement 7]

An image processing method by an image processing device, the image processing method including:
cutting out an image of a rectangular region including a predetermined object from an input image as a cutout image;
performing standardization of a size of the cutout image to a predetermined size while maintaining an aspect ratio of the object; and
outputting a cutout image after the standardization, in which
standardization of the size of the cutout image to the predetermined size is performed by adding predetermined images in a width direction and a height direction of the cutout image in a case where the size of the cutout image is less than or equal to the predetermined size in both the width direction and the height direction, and standardization of the size of the cutout image to the predetermined size is performed by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

### [Supplement 8]

A non-transitory storage medium storing a program executable by a computer, the non-transitory storage medium storing a program that causes the computer to operate as the image processing device according to supplement 1.

Although the above embodiments have been described as typical examples, it is obvious to those skilled in the art that many modifications and substitutions can be made within the spirit and scope of the present disclosure. Thus, it should not be understood that the present invention is limited by the embodiments described above, and various modifications or changes can be made without departing from the scope of the claims. For example, a plurality of configuration blocks described in the configuration diagram of the embodiments can be combined into one, or one configuration block can be divided.

### REFERENCE SIGNS LIST

10 Image processing device
11 Image input unit
12 Image cutting-out unit
13 Image size standardization unit
14 Image output unit
21 Processor
22 ROM
23 RAM
24 Storage
25 Input unit
26 Display unit
27 Communication I/F
29 Bus

1. An image processing device comprising:
an image cutting-out unit that cuts out an image of a rectangular region including a predetermined object from an input image as a cutout image;
an image size standardization unit that performs standardization of a size of the cutout image to a predetermined size while maintaining an aspect ratio of the object; and
an image output unit that outputs a cutout image after the standardization, wherein
the image size standardization unit performs standardization of the size of the cutout image to the predetermined size by adding predetermined images in a width direction and a height direction of the cutout image in a case where the size of the cutout image is less than or equal to the predetermined size in both the width direction and the height direction, and performs standardization of the size of the cutout image to the predetermined size by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

2. The image processing device according to claim 1, wherein
the image size standardization unit adds, as the predetermined images, images including uniform pixels to the cutout image.

3. The image processing device according to claim 1, wherein
the image size standardization unit adds, as the predetermined images, images around the cutout image in the input image to the cutout image.

4. The image processing device according to claim 1, wherein
the image size standardization unit adds the predetermined images symmetrically to both sides in the width direction of the cutout image and/or adds the predetermined images symmetrically to both sides in the height direction of the cutout image.

5. The image processing device according to claim 3, wherein
the image size standardization unit adds the images around the cutout image in the input image asymmetrically in the width direction of the cutout image and/or adds the images around the cutout image in the input image asymmetrically in the height direction of the cutout image.

6. The image processing device according to claim 5, wherein
the image size standardization unit adds the images around the cutout image in the input image to the cutout image such that a pixel value of a pixel constituting the image to be added to the cutout image approaches a predetermined pixel value.

7. An image processing method by an image processing device, the image processing method comprising:
cutting out an image of a rectangular region including a predetermined object from an input image as a cutout image;
performing standardization of a size of the cutout image to a predetermined size while maintaining an aspect ratio of the object; and
outputting a cutout image after the standardization, wherein
standardization of the size of the cutout image to the predetermined size is performed by adding predetermined images in a width direction and a height direction of the cutout image in a case where the size of the cutout image is less than or equal to the predetermined size in both the width direction and the height direction, and standardization of the size of the cutout image to the predetermined size is performed by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

8. (canceled)

9. The image processing method according to claim 7, further comprising:
adding, as the predetermined images, images including uniform pixels to the cutout image.

10. The image processing method according to claim 7, further comprising:
adding, as the predetermined images, images around the cutout image in the input image to the cutout image.

11. The image processing method according to claim 7, further comprising:
adding the predetermined images symmetrically to both sides in the width direction of the cutout image and/or adds the predetermined images symmetrically to both sides in the height direction of the cutout image.

12. The image processing method according to claim 7, further comprising:
adding the images around the cutout image in the input image asymmetrically in the width direction of the cutout image and/or adds the images around the cutout image in the input image asymmetrically in the height direction of the cutout image.

13. The image processing method according to claim 12, wherein
adding the images around the cutout image in the input image to the cutout image such that a pixel value of a pixel constituting the image to be added to the cutout image approaches a predetermined pixel value.

14. A computer-readable non-transitory recording medium storing computer-executable program instructions that when executed by a processor cause a computer to execute an image processing method comprising:
cutting out an image of a rectangular region including a predetermined object from an input image as a cutout image;
performing standardization of a size of the cutout image to a predetermined size while maintaining an aspect ratio of the object; and
outputting a cutout image after the standardization, wherein
standardization of the size of the cutout image to the predetermined size is performed by adding predetermined images in a width direction and a height direction of the cutout image in a case where the size of the cutout image is less than or equal to the predetermined size in both the width direction and the height direction, and standardization of the size of the cutout image to the predetermined size is performed by adding predetermined images in at least one of the width direction or the height direction of the cutout image to generate an additional image having an aspect ratio identical to that of the predetermined size and compressing the additional image to the predetermined size in a case where the size of the cutout image is greater than the predetermined size in at least one of the width direction or the height direction.

15. The computer-readable non-transitory recording medium according to claim 14 wherein the image processing method further comprises:
adding, as the predetermined images, images including uniform pixels to the cutout image.

16. The computer-readable non-transitory recording medium according to claim 14 wherein the image processing method further comprises:
adding, as the predetermined images, images around the cutout image in the input image to the cutout image.

17. The computer-readable non-transitory recording medium according to claim 14 wherein the image processing method further comprises:
adding the predetermined images symmetrically to both sides in the width direction of the cutout image and/or adds the predetermined images symmetrically to both sides in the height direction of the cutout image.

18. The computer-readable non-transitory recording medium according to claim 16 wherein the image processing method further comprises:
adding the images around the cutout image in the input image asymmetrically in the width direction of the cutout image and/or adds the images around the cutout image in the input image asymmetrically in the height direction of the cutout image.

19. The computer-readable non-transitory recording medium according to claim 18 wherein the image processing method further comprises:
adding the images around the cutout image in the input image to the cutout image such that a pixel value of a pixel constituting the image to be added to the cutout image approaches a predetermined pixel value.

20. The image processing device according to claim 1, further comprising:
a display comprising a touch panel system wherein the touch panel system comprises an input unit.

21. The image processing device according to claim 1, further comprising:
an image input unit comprising a communication interface, wherein the communication interface outputs a standardized clipped image.
